(19) United States
(12) Patent Application Publication
(10) Pub. No.: US 2015/0097785 A1
(43) Pub. Date: Apr. 9, 2015

(54) DISPLAY DEVICE

(71) Applicants: Masakazu Shoji, Tokyo (JP); Mitsuo Shimotani, Tokyo (JP); Hiroki Fujisawa, Tokyo (JP); Keisuke Kobayashi, Tokyo (JP); Yuji Nobe, Tokyo (JP)

(72) Inventors: Masakazu Shoji, Tokyo (JP); Mitsuo Shimotani, Tokyo (JP); Hiroki Fujisawa, Tokyo (JP); Keisuke Kobayashi, Tokyo (JP); Yuji Nobe, Tokyo (JP)

(73) Assignee: Mitsubishi Electric Corporation, Tokyo (JP)

(21) Appl. No.: 14/391,221

(22) PCT Filed: Jun. 14, 2012
(86) PCT No.: PCT/JP2012/003899

§ 371 Date: Oct. 8, 2014

(51) Int. Cl. G06F 3/01

(52) U.S. Cl. CPC G06F 3/016
USPC 345/173

(57) ABSTRACT

A display device includes a touch panel 3 that has a touch operation area wider than an image display area, an operation member formed in an area 3b, other than the image display area, in the touch operation area, and an operation feeling generator 7 that provides an operation feeling for a pointing object which has operated the operation member.

### FIELD OF THE INVENTION

The present invention relates to a display device equipped with a touch panel.

### BACKGROUND OF THE INVENTION

For example, a touch panel device having a mechanism of feeding a tactile feeling according to a touch operation back to an operator who has operated a touch panel is disclosed by patent reference 1.

This device includes a case having an access window which is opened, a touch panel accommodated in this case, an image display device placed on a rear surface side of the touch panel, and a belt-shaped piezoelectric element disposed on an image display device side of the touch panel and at a position corresponding to a portion surrounding the access window. A portion of the touch panel which corresponds to the portion surrounding the access window is fixed to the case, and, every time when the touch panel is touched via the access window, an operation of applying a voltage to the piezoelectric element to make this piezoelectric element contract in a direction of its length, and stopping the application of the voltage after that is repeated.

### RELATED ART DOCUMENT

### Patent Reference

Patent reference 1: Japanese Unexamined Patent Application Publication No. 2011-175364

### SUMMARY OF THE INVENTION

### Problems to be Solved by the Invention

In recent years, operating procedures using a touch panel have been diversified, and have been used not only for an operation on a touch operation area which is superimposed on an image display area, but also for an operation on an area outside the image display area. For example, there has been provided a display device in which a touch operation area is formed in such a way as to be wider than an image display area, and an operation member regarding a specific operation is also formed in an area, other than the image display area, in the touch operation area.

An operation member displayed in the image display area as an icon image or an operation button image changes the display of the image thereof according to an operation thereon in many cases even if no operation feeling is provided for an operator's finger which has operated the operation member, and therefore the operator can easily recognize that he or she has operated the operation member appropriately.

A problem is, however, that because the image of an operation member disposed outside the image display area is formed by using back surface printing on a rear surface side of the touch panel, the image of the operation member does not change even if the operation member is operated, and it is therefore difficult for the operator to determine whether or not he or she has been able to operate the operation member appropriately if no operation feeling is provided for the operator's finger which has operated the operation member.

For example, in a case which a “return” button for returning to previous processing results is formed in an area outside the image display area, when a Web search and so on are performed in turn, and, after the “return” button is operated during this performance, and search results similar to those shown before this return are displayed, the operator may be confused about whether he or she has been able to operate the button appropriately because the image of the “return” button does not change and no operation feeling is provided for the operator.

The conventional technique represented by patent reference 1 is the one of feeding back a tactile feeling according to a touch operation in order to make the operator realize he or she has operated a touch panel.

However, because the conventional technique is targeted at the touch operation area superimposed on the image display area, the above-mentioned problem regarding operation members disposed outside the image display area cannot be solved.

Further, there is a case in which the driver of a vehicle cannot sufficiently recognize contents displayed on the display device of a vehicle-mounted information device visually because the driver needs to concentrate on driving the vehicle. Particularly, it is difficult for the driver to recognize whether he or she has been able to operate an operation member formed in an area, other than the image display area, in the touch operation area appropriately.

The present invention is made in order to solve the above-mentioned problems, and it is therefore an object of the present invention to provide a display device that can provide an operation feeling appropriately for a pointing object which has operated an operation member formed in an area, other than an image display area, in a touch operation area.

### Means for Solving the Problem

In accordance with the present invention, there is provided a display device including: a touch panel that has a touch operation area wider than an image display area; an operation member formed in an area, other than the image display area, in the touch operation area; and an operation feeling generator that provides an operation feeling for a pointing object which has operated the operation member.

### Advantages of the Invention

In accordance with the present invention, there is provided advantage of being able to provide the operation feeling appropriately for the pointing object which has operated the operation member formed in the area, other than the image display area, in the touch operation area.

### BRIEF DESCRIPTION OF THE FIGURES

FIG. 1 is a view showing a display device in accordance with Embodiment 1 of the present invention;

FIG. 2 is a view showing an operation member formed outside an image display area in accordance with Embodiment 1.

FIG. 3 is a cross-sectional view showing another example of the structure of the operation member formed outside the image display area in accordance with Embodiment 1;

FIG. 4 is a view showing a display device in accordance with Embodiment 2 of the present invention;

FIG. 5 is a cross-sectional view showing another example of the structure of an operation member formed outside an image display area in accordance with Embodiment 2;

FIG. 6 is a view showing a display device in accordance with Embodiment 3 of the present invention; and

FIG. 7 is a view showing a display device in accordance with Embodiment 4 of the present invention.

### EMBODIMENTS OF THE INVENTION

Hereafter, in order to explain this invention in greater detail, the preferred embodiments of the present invention will be described with reference to the accompanying drawings.

### Embodiment 1

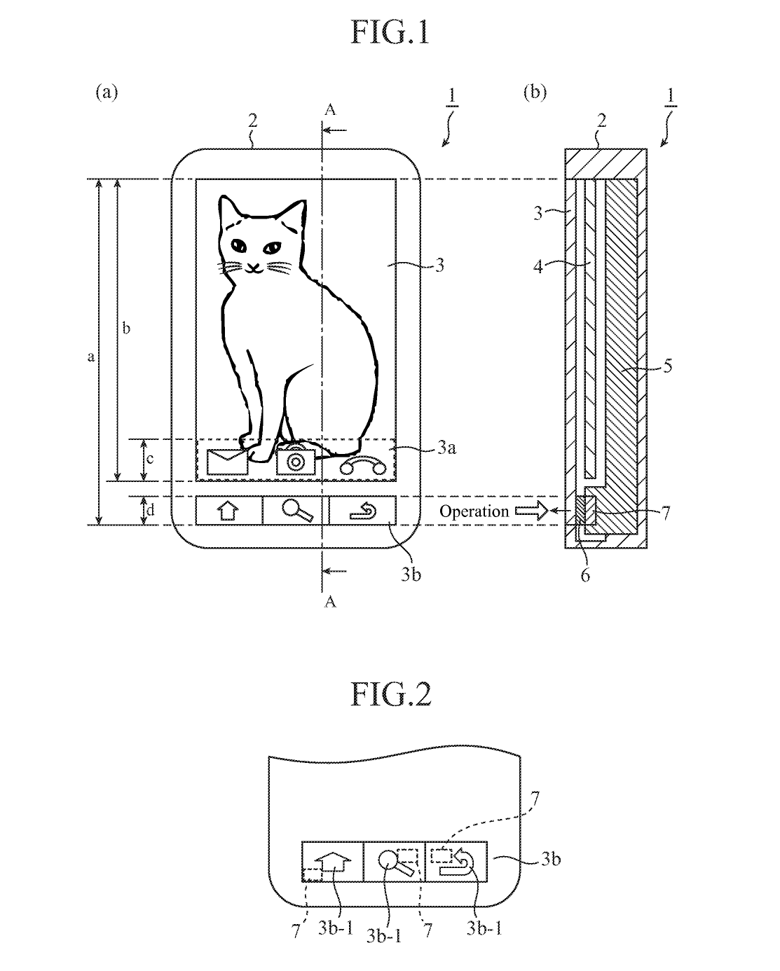

FIG. 1 is a view showing a display device in accordance with Embodiment 1 of the present invention. FIG. 1(a) is a front view of the display device in accordance with Embodiment 1, and FIG. 1(b) is a cross-sectional view indicated by arrows and schematically showing a cross section taken along the A-A line of FIG. 1(a). The display device 1 shown in FIG. 1 is applied to, for example, information processing equipment, such as a smart phone, a tablet PC, or a PND (Portable Navigation Device). A housing case 2 of the display device 1 is a box-shaped one whose image display surface side in which a touch panel 3 is incorporated is opened, as shown in FIG. 1(b), and accommodates a liquid crystal display panel 4 and an internal circuit 5 therein.

The touch panel 3 has a structure in which, for example, two transparent electrode sheets are laminated via a spacing member therebetween, and is constructed in such a way that when the upper and lower transparent electrodes are locally brought into contact with each other by a push performed by a pointing object, the coordinates of the pushed position are detected.

Further, in the display device 1, a touch operation area of the touch panel 3 (having a longitudinal size of a) is wider than an image display area (having a longitudinal size of b), and an operation area 3a (having a longitudinal size of c) is formed in the image display area and an operation area 3b (having a longitudinal size of d) is formed outside the image display area, as shown in FIG. 1(a).

The operation area 3a is the one in which symbols or characters showing descriptions of operation members therein are displayed in the image display area as icon images or button images (in the example of FIG. 1(a), an e-mail icon, a camera icon, and a phone icon). Each of these icon images or button images is touch-operated by a pointing object and a process according to the operation description is performed. At this time, no operation feeling is generated.

In a region on a rear surface side of the touch panel 3 corresponding to the operation area 3b, a printed member 6 on which a non-transparent print is produced is formed as shown in FIG. 1(b). In the printed member 6, the non-transparent print of a portion corresponding to each of the symbols or characters showing the descriptions of the operation members in the operation area 3b is removed, or after the non-transparent print of the portion corresponding to each of the symbols or characters is removed, a transparent print is produced. The portion corresponding to each of the symbols or characters showing the descriptions of the operation members allows light from a light source placed on the rear surface side of the touch panel 3 to pass therethrough, so that the portion is illuminated.

The display device 1 in accordance with the present invention includes operation feeling generators 7 each of that, when the operation member in the operation area 3b is pushed (operated in a direction of an arrow shown in FIG. 1(b)), provides an operation feeling for a pointing object, such as a finger or a stylus pen, which has operated the operation member. The operation feeling which each of the operation feeling generators 7 generates is the one which is generated when the pointing object performs an operation of pushing the operation member in the operation area 3b and then detaching from the operation member, and a click feeling, a vibration, or the like is provided as the operation feeling.

FIG. 2 is a view showing the operation members which are formed outside the image display area in accordance with Embodiment 1, and is the one showing the operation members in the operation area 3b which are viewed from the front of the operation members. As shown in FIG. 2, the operation feeling generators 7 are placed at positions which are slightly apart from those of the symbols (or characters) showing the descriptions of the operation members, respectively. More specifically, on a rear surface side of the operation area 3b, illuminating members 3b-1 that illuminate the symbols (or characters) are disposed adjacent to the operation feeling generators 7, respectively. By constructing the display device this way, it can provide both the illumination for specifying the operation members visually and the operation feeling for causing an operation on each of the operation members to be recognized tactilely.

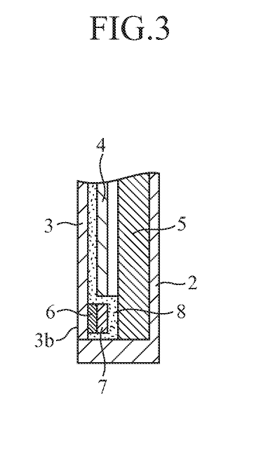

FIG. 3 is a cross-sectional view showing another example of the structure of the operation members formed outside the image display area in accordance with Embodiment 1. In the structure shown in FIG. 3, a flexible transparent resin 8 is filled in a portion between the rear surface of the touch panel 3 and the display surface of the liquid crystal display panel 4, and on a rear surface side of the operation feeling generators 7. The transparent resin 8 has a high degree of transparency and high shock resistance. For example, a polycarbonate (PC) resin or an acrylic resin (poly methyl methacrylate (PMMA) resin) is used.

In order to convey the operation feeling generated by each operation feeling generator 7 to the pointing object more effectively, it is desirable for the operation member in the operation area 3b to become deformed elastically by an amount by which the operation member is pushed.

To this end, as the touch panel 3, a so-called film-shaped touch panel that is constructed of a film-shaped member which becomes deformed elastically because of a load applied thereto from outside the member is used. At this time, in order to prevent a strong shock from being applied to the liquid crystal display panel 4 and each of the operation feeling generators 7, the transparent resin 8 as shown in FIG. 3 is filled. As a result, an excessive load is absorbed by the transparent resin 8.

As mentioned above, the display device in accordance with this Embodiment 1 includes the touch panel 3 that has the touch operation area wider than the image display area, the operation members formed in the area 3b, other than the image display area, in the touch operation area, and the operation feeling generators 7 each of that provides an operation feeling for a pointing object which operates the operation member.

By constructing the display device this way, it can appropriately provide the operation feeling for the pointing object which operates each of the operation members formed in the area 3b, other than the image display area, in the touch operation area.

### Embodiment 2

In above-mentioned Embodiment 1, the case in which the operation area 3b is in the same plane as the other areas in the touch operation area, i.e., they have the same surface state is shown. In this structure, it is impossible to distinguish between an operation member disposed outside the image display area and an operation member disposed in the image display area by using only a tactile sense.

To solve this problem, in accordance with this Embodiment 2, operation members disposed outside an image display area are formed to be placed in a surface state stereoscopically different from that of other areas in a touch operation area. For example, the operation members are formed to be placed in a surface state in which they are projecting or recessed.

As a result, the operation members disposed outside the image display area are distinguishable from other operation members by using a tactile sense.

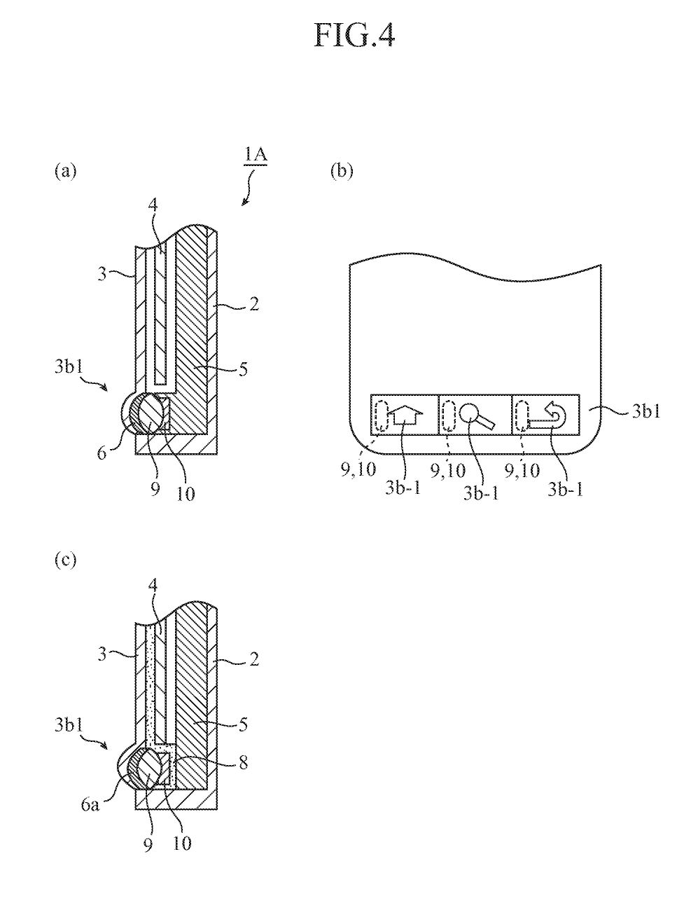

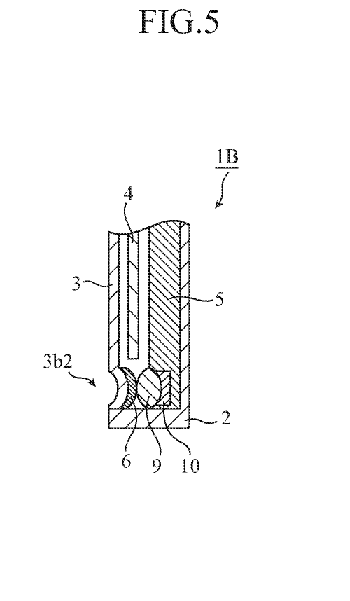

FIG. 4 is a view showing a display device in accordance with Embodiment 2 of the present invention, and the operation members disposed outside the image display area have a surface state in which they are projecting. FIG. 4(a) is a cross-sectional view indicated by arrows and schematically showing a cross section, taken along the line at the same position as the A-A line of FIG. 1(a), of the display device 1A in accordance with Embodiment 2, FIG. 4(b) is a front view of the operation members in an operation area 3b1, and FIG. 4(c) is a cross-sectional view showing another example of the structure of the operation members in the operation area 3b1.

In the display device 1A in accordance with Embodiment 2, the touch operation area of a touch panel 3 is wider than the image display area, and an operation area 3a is formed in the image display area, and the operation area 3b1 is formed outside the image display area, like in the case of above-mentioned Embodiment 1.

A film-shaped touch panel shown in FIG. 3 is used as the touch panel 3. A portion corresponding to the operation members in the operation area 3b1 is formed to be elevated against the other areas in the touch operation area, as shown in FIG. 4(a). On a rear surface side of the operation area 3b1, a printed member 6 on which a non-transparent print is produced is formed, like in the case of above-mentioned Embodiment 1. In the printed member 6, the non-transparent print of a portion corresponding to each of symbols or characters showing descriptions of the operation members in the operation area 3b1 is removed, or after the non-transparent print of the portion corresponding to each of the symbols or characters is removed, a transparent print is produced.

On a rear surface side of the operation members in the operation area 3b1, expansion elements 9 each of which functions as an operation feeling generator and their control circuits 10 are placed. Each of the expansion elements 9 expands in response to a supply of an electric signal. For example, as each of the expansion elements 9, an element having a structure of sealing an electrolytic solution therein is disposed on the rear surface side of the operation member in the operation area 3b1. When an electric signal is supplied thereto, this element generates a gas therewithin and expands. Each of the control circuits 10 is a controller that controls the expansion of the expansion element 9, and, when a pushing operation is performed on the operation member, supplies an electric signal to the expansion element 9 corresponding to the operation member.

When a pointing object pushes an operation member projecting in the operation area 3b1, the control circuit 10 reads a touch detection signal of the touch panel 3, and supplies the electric signal to the expansion element 9 disposed at the position corresponding to the operation member. When the electric signal is supplied thereto from the control circuit 10, the expansion element 9 expands against the pushing operation of the pointing object, and, when the pointing object further pushes the operation member, is further pushed. Changes of a reaction force at this time are provided for the pointing object as an operation feeling (click feeling).

Further, as shown in FIG. 4(b), the sets of expansion element 9 and control circuit 10 are placed at positions which are slightly apart from the symbols (or characters) showing the descriptions of the operation members, respectively. More specifically, on the rear surface side of the operation area 3b1, illuminating members 3b-1 that illuminate the symbols (or characters) are disposed adjacent to the sets of expansion element 9 and control circuit 10, respectively. By constructing the display device this way, it can provide both the illumination for specifying the operation members visually and an operation feeling for causing an operation on each of the operation members to be recognized tactilely.

In addition, as shown in FIG. 4(c), a flexible transparent resin 8 can be filled in a portion between the rear surface of the touch panel 3 and the display surface of a liquid crystal display panel 4, and on a rear surface side of the control circuits 10, like in the case of the structure of FIG. 3. Because it is necessary to convey the reaction force caused by the expansion of each of the expansion elements 9 to the pointing object via the touch panel 3, it is desirable to use a film-shaped touch panel as the touch panel 3 in Embodiment 2.

Therefore, in order to prevent a strong shock from being applied to the liquid crystal display panel 4, the expansion elements 9, and the control circuits 10, the transparent resin 8 is filled. As a result, an excessive load is absorbed by the transparent resin 8.

FIG. 5 is a cross-sectional view showing another example of the structure of the operation members formed outside the image display area in accordance with Embodiment 2. The display device 1B shown in FIG. 5 has a surface state in which the operation members disposed outside the image display area have a recessed structure contrary to that shown in FIG. 4. Also in the display device 1B, the touch operation area of the touch panel 3 is wider than the image display area, and an operation area 3a is formed in the image display area, and an operation area 3b2 is formed outside the image display area.

As shown in FIG. 5, a portion corresponding to the operation members in the operation area 3b2 is recessed against the other areas of the touch operation area. On a rear surface side of the operation area 3b2, a printed member 6 on which a non-transparent print is produced is formed, like in the case of above-mentioned Embodiment 1. On a rear surface side of the operation members in the operation area 3b2, expansion elements 9 each of which constructs an operation feeling generator and their control circuits 10 are placed.

When an pointing object pushes an operation member recessed in the operation area 3b2, the control circuit 10 reads a touch detection signal of the touch panel 3, and supplies the electric signal to the expansion element 9 disposed at the position corresponding to the operation member. When the electric signal is supplied thereto from the control circuit 10, the expansion element 9 expands against the pushing operation of the pointing object, and, when the pointing object further pushes the operation member, is further pushed. Changes of the reaction force at this time are provided for the pointing object as an operation feeling (click feeling), like in the case of a projecting operation member.

Although the structure in which the operation members disposed outside the image display area are projecting or recessed is shown in the above-mentioned explanation, the present invention is not limited to this structure. More specifically, the operation members disposed outside the image display area should just have a surface state stereoscopically different from that of the other areas to such an extent that the operation members can be recognized by using a tactile sense.

For example, instead of the structure of making the operation members have a projecting or recessed shape, there can be considered a structure of making the surface of the entire operation area 3b1 have a dimple shape with small asperities, or a structure of making the surface of the entire operation area 3b1 have roughness.

Further, although the case in which the sets of expansion element 9 and control circuit 10 are respectively disposed for the operation members whose surfaces are projecting or recessed is shown, the display device can be constructed in such a way that an expansion element 9 and a control circuit 10 are disposed for each operation member which is flat like those in the case of above-mentioned Embodiment 1, and the expansion element is expanded against a pushing operation (is elevated from its flat state) to provide a reaction force (operation feeling) for a pointing object.

As mentioned above, in accordance with this Embodiment 2, the operation members in the operation area 3b1 (or in the operation area 3b2) are formed to be placed in a surface state stereoscopically different from that of an area, other than the operation members, in the touch operation area. Particularly, the operation members are made to have a surface state in which they are projecting or recessed against the area, other than the operation members, in the touch operation area. By constructing the display device this way, the operation members disposed outside the image display area are distinguishable from other operation members by using a tactile sense. For example, because in the case of a vehicle-mounted information device, the driver cannot look at the display device while concentrating on driving, the recognition of an operation member using a tactile sense is effective.

Further, because in accordance with this Embodiment 2 each set of expansion element 9 and control circuit 10 provides a reaction force as an operation feeling by expanding against a push performed by a pointing object, the operation feeling can be provided appropriately for the pointing object which has operated an operation member formed in the operation area 3b1 (or in the operation area 3b2).

### Embodiment 3

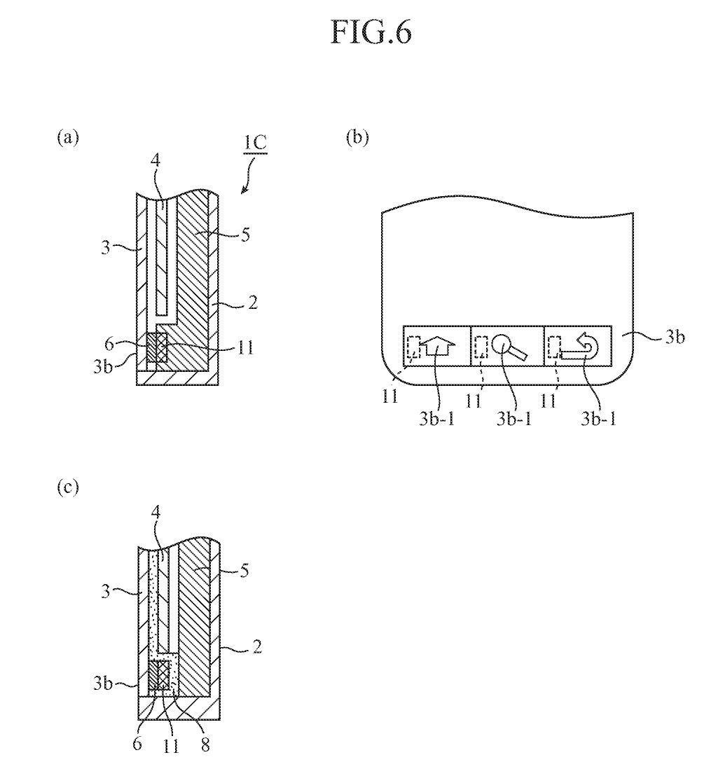

FIG. 6 is a view showing a display device in accordance with Embodiment 3 of the present invention, and the display device 1C in accordance with Embodiment 3 provides a vibration as an operation feeling for a pointing object which has operated an operation member disposed outside an image display area. FIG. 6(a) is a cross-sectional view indicated by arrows and schematically showing a cross section, taken along the line at the same position as the A-A line of FIG. 1(a), of the display device 1C in accordance with Embodiment 3, FIG. 6(b) is a front view of operation members disposed outside the image display area, and FIG. 6(c) is a cross-sectional view showing another example of the structure of the operation members disposed outside the image display area. In the display device 1C in accordance with Embodiment 3, a touch operation area of a touch panel 3 is wider than the image display area, and an operation area 3a is formed in the image display area, and an operation area 3b is formed outside the image display area, like in the case of above-mentioned Embodiment 1.

The operation area 3b has the same surface state as that of the other areas in the touch operation area. Further, on a rear surface side of the operation area 3b, a printed member 6 on which a non-transparent print is produced is formed, like in the case of above-mentioned Embodiment 1. In the printed member 6, the non-transparent print of a portion corresponding to each of symbols or characters showing descriptions of the operation members in the operation area 3b is removed, or after the non-transparent print of the portion corresponding to each of the symbols or characters is removed, a transparent print is produced.

On a rear surface side of the operation members in the operation area 3b, oscillation circuits 11 each of which functions as an operation feeling generator are placed. Each of the oscillation circuits 11 is comprised of a vibration element that vibrates in response to a supply of an electric signal, and a control circuit that supplies the electric signal to this vibration element. As the vibration element, for example, a piezoelectric element is used.

When a pointing object pushes an operation member in the operation area 3b, the oscillation circuit 11 reads a touch detection signal of the touch panel 3, and supplies the electric signal to the vibration element corresponding to the operation member. When the electric signal is supplied thereto, the vibration element vibrates and this vibration propagates to the touch panel 3. This vibration is provided for the pointing object as an operation feeling.

Further, as shown in FIG. 6(b), the oscillation circuits 11 are placed at positions which are slightly apart from the symbol (or characters) showing descriptions of the operation members, respectively. More specifically, on a rear surface side of the operation area 3b, illuminating members 3b-1 that illuminate the symbols (or characters) are disposed adjacent to the oscillation circuits 11, respectively. By constructing the display device this way, it can provide both the illumination for specifying the operation members visually and an operation feeling for causing an operation on each of the operation members to be recognized tactilely.

In addition, as shown in FIG. 6(c), a flexible transparent resin 8 can be filled in a portion between the rear surface of the touch panel 3 and the display surface of a liquid crystal display panel 4, and on a rear surface side of the oscillation circuits 11, like in the case of the structure of FIG. 3. Because it is necessary to propagate the vibration of each of the vibration elements to a pointing object via the touch panel 3, it is desirable to use a film-shaped touch panel as the touch panel 3 in Embodiment 3.

Therefore, in order to prevent a strong shock from being applied to the liquid crystal display panel 4 and the oscillation circuits 11, the transparent resin 8 is filled. As a result, an excessive load is absorbed by the transparent resin 8.

As mentioned above, because in accordance with this Embodiment 3 each of the oscillation circuits 11 provides a vibration to a pointing object as an operation feeling, the operation feeling can be provided appropriately for the pointing object which has operated an operation member formed in the area 3b, other than the image display area, in the touch operation area.

Although the case in which the oscillation circuits 11 are disposed as the operation feeling generators 7 in the structure of FIG. 1 is shown in above-mentioned Embodiment 3, the oscillation circuits 11 can be disposed instead of the structure in accordance with above-mentioned Embodiment 2, i.e., the expansion elements 9 and the control circuits 10 in the structure of FIG. 4. Even if the display device is constructed this way, the same advantage as that mentioned above can be provided.

### Embodiment 4

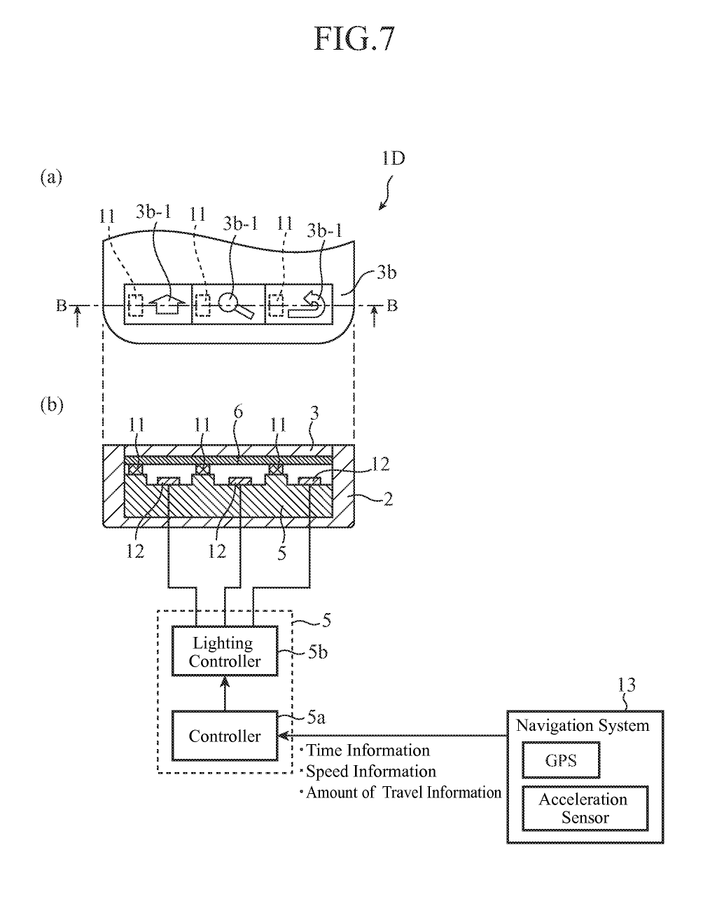

FIG. 7 is a view showing a display device in accordance with Embodiment 4 of the present invention, FIG. 7(a) shows a front view of operation members disposed outside an image display area in accordance with Embodiment 1, and FIG. 7(b) shows a schematic cross-sectional view taken along the B-B line of FIG. 7(a), and functional blocks of an internal circuit 5.

The display device 1D shown in FIG. 7 provides a vibration as an operation feeling for a pointing object which has operated an operation member disposed outside the image display area, like, for example, that in accordance with above-mentioned Embodiment 3.

On a rear surface side of an operation area 3b, a printed member 6 on which a non-transparent print is produced is formed, like in the case of above-mentioned Embodiment 1. In the printed member 6, the non-transparent print of a portion corresponding to each of symbols or characters showing descriptions of the operation members in the operation area 3b is removed, or after the non-transparent print of the portion corresponding to each of the symbols or characters is removed, a transparent print is produced. Further, a portion corresponding to each of the symbols or characters showing the descriptions of the operation members allows light from a light source 12 placed on a rear surface side of a touch panel 3 to pass therethrough, so that the portion is illuminated, as shown in FIG. 7(b).

As shown in FIG. 7(a), oscillation circuits 11 are placed at positions which are slightly apart from the symbols (or characters) showing the descriptions of the operation members, respectively. More specifically, on the rear surface side of the operation area 3b, illuminating members 3b-1 that illuminate the symbols (or characters) are disposed adjacent to the oscillation circuits 11, respectively. By constructing the display device this way, it can provide both the illumination for specifying the operation members visually and an operation feeling for causing an operation on each of the operation members to be recognized tactilely.

The internal circuit 5 is provided with a controller 5a and a lighting controller 5b as the functional blocks. The controller 5a controls a lighting operation of lighting the light source 12 which is performed by the lighting controller 5b according to an operation performed by a pointing object. Further, the lighting controller 5b controls the lighting operation of lighting the light source 12 according to the control performed by the controller 5a.

The controller 5a controls the lighting operation of lighting the light source 12 which is performed by the lighting controller 5b according to an operation performed by a pointing object, thereby providing an illumination state according to the operation performed by the pointing object. For example, the display device illuminates the operation members with red light before an operation is performed, and illuminates the operation members with blue light according to the operation performed by the pointing object. In this case, the red illumination shows that any information processing is at rest, and the blue illumination shows that information processing according to the operation performed by the pointing object is in progress.

Further, the controller 5a determines surrounding conditions on the basis of time information, speed information, and amount of travel information which are acquired from a navigation system 13, and controls the lighting controller 5b in such a way that the display device is placed in an illumination state according to the surrounding conditions.

More specifically, various lighting patterns are preset to the controller 5a, the lighting patterns each being brought into correspondence with surrounding conditions, which are determined from the time information, the speed information, and the amount of travel information. The controller controls the lighting controller 5b in such a way that the light source 12 provides a lighting pattern according to the surrounding conditions corresponding to the various pieces of information acquired from the navigation system 13. The lighting pattern is defined by the luminance (the brightness of the light), the chromaticity (the tint of the light), and a difference between continuous lighting and discontinuous lighting (blinking) of the illumination provided by the light source 12.

For example, in a case in which the display device 1D is mounted in a vehicle-mounted information device, when the speed is a medium-low one and the amount of travel is equal to or smaller than a predetermined range, the display device selects a lighting pattern in which the luminance and the tint of the illumination are set to be equal to or less than predetermined values and long-interval blinking is done because the driver is placed in a state in which he or she does not have to concentrate on driving as compared with a situation in which the driver is driving at a high speed and has driven for a long time. As a result, the power consumption of the vehicle battery can also be reduced.

In contrast, when the speed is a high one and the amount of travel exceeds the predetermined range, the display device selects a lighting pattern in which the luminance and the tint of the illumination are set to be values exceeding the predetermined values and continuous lighting or short-interval blinking is done, thereby raising the visibility of the operation members, because the driver is placed in a state in which he or she must concentrate on driving than usual. As a result, the driver can visually recognize the operation members of the display device 1D (the operation members disposed outside the image display area) in an instant.

Further, there can be considered a case in which when the display device operates in cooperation with the navigation system 13, and the driver is driving in the neighborhood of a school zone and information indicating school commuting hours is provided as the time information, the display device selects the above-mentioned lighting pattern which raises the visibility. The operation members disposed outside the image display area correspond to the predetermined operation descriptions (“return”, “search”, “display menu”, etc.), respectively, and accept operating procedures (touch operation, etc.) simpler than those for operation members in the image display area. Therefore, there is a high possibility that the operation members disposed outside the image display area are operated even when the driver is driving the vehicle. To solve this problem, by illuminating the operation members by using the above-mentioned lighting pattern, the convenience can be further improved.

The user can be allowed to properly set up a correspondence between the surrounding conditions, which are determined from the time information, the speed information, and the amount of travel information, and the various lighting patterns by using an input unit.

The navigation system 13 performs navigation processes, such as a route search, route guidance, and map display. The display device 1D in accordance with Embodiment 1 can be a one of a vehicle-mounted information device different from the navigation system 13, or can be a one mounted in the navigation system 13.

The navigation system 13 acquires time information and position information about the vehicle (latitude and longitude) from a result of an analysis of GPS radio waves received by a GPS (Global Positioning System) receiver. As an alternative, the navigation system can detect position information by using a self-contained navigation device with an acceleration sensor etc.

As mentioned above, the display device in accordance with this Embodiment 4 includes the illuminating members 3b-1 that illuminate the operation members disposed outside the image display area from the rear surface side of the touch panel 3, and the controller 5a and the lighting controller 5b that control the illuminating operations of the illuminating members 3b-1 according to an operation performed by a pointing object. By constructing the display device this way, it can provide the same advantages as those provided by above-mentioned embodiments, and can also improve the visibility and the convenience of the operation members disposed outside the image display area.

Further, because in accordance with this Embodiment 4 the controller 5a and the lighting controller 5b change the illumination of the operation members to a different illumination state according to the surrounding conditions, the visibility and the convenience of the operation members disposed outside the image display area can be improved.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the display device in accordance with the present invention can appropriately provide an operation feeling for a pointing object which has operated an operation member formed in an area, other than an image display area, in a touch operation area, the display device is suitable for use as a display device of a vehicle-mounted information device which may be placed in an environment in which the image display area cannot be recognized visually, such as a situation in which the driver is driving.

### EXPLANATIONS OF REFERENCE NUMERALS

1, 1A to 1D display device, 2 housing case, 3 touch panel, 3a, 3b, 3b1, and 3b2 operation area, 3b-1 illuminating member, 4 liquid crystal display panel, 5 internal circuit, 5a controller, 5b lighting controller, 6 printed member, 7 operation feeling generator, 8 transparent resin, 9 expansion element, 10 control circuit, 11 oscillation circuit, 12 light source, 13 navigation system.

1-7. (canceled)

8. A display device comprising:
a touch panel that has a touch operation area wider than an image display area;
an operation member formed in an area, other than said image display area, in said touch operation area; and
an operation feeling generator that provides an operation feeling for a portion of said operation member which has been operated.

9. The display device according to claim 8, wherein in said image display area, a display screen changes according to an operation on said image display area, and, in said operation member, an operation feeling occurs according to an operation on said operation member.

10. The display device according to claim 8, wherein said operation member is placed in a surface state stereoscopically different from that of an area, other than said operation member, in said touch operation area.

11. The display device according to claim 10, wherein said operation member is placed in a surface state in which said operation member is projecting or recessed against the area, other than said operation member, in said touch operation area.

12. The display device according to claim 8, wherein said operation feeling generator expands against a push of said operation member, thereby providing a reaction force as the operation feeling.

13. The display device according to claim 12, wherein said operation feeling generator provides the operation feeling when said operation feeling generator is pushed by a further push of said operation member.

14. The display device according to claim 8, wherein said operation feeling generator provides a vibration for said operation member as the operation feeling.

15. The display device according to claim 8, wherein said display device comprises an illuminator that illuminates said operation member from a rear surface side of said touch panel and a controller that controls an illuminating operation of said illuminator according to an operation on said operation member.

16. The display device according to claim 15, wherein said operation feeling generator provides a vibration for said operation member as the operation feeling, and a position illuminated differs from a position for which the vibration is provided.

17. The display device according to claim 15, wherein said controller changes the illumination on said operation member to a different illumination state according to surrounding conditions.
